(19) United States
(12) Patent Application Publication
(10) Pub. No.: US 2009/0058680 A1
(43) Pub. Date: Mar. 5, 2009

(54) Traffic Safety Arrow Systems And Methods

(76) Inventor: Llewellyn Richard Benn, Brooklyn, NY (US)

Correspondence Address: LATHROP & GAGE LC, 4845 PEARL EAST CIRCLE, SUITE 300, BOULDER, CO, 80301, US

(21) Appl. No.: 12/203,820

(22) Filed: Sep. 3, 2008

Related U.S. Application Data
(60) Provisional application No. 60/969,797, filed on Sep. 4, 2007.

(51) Int. Cl. E01F 9/00; G08G 1/095

(52) U.S. Cl. 340/908.1; 340/908

(57) ABSTRACT

Traffic safety systems and method impart traffic control information to traffic in a construction zone. The traffic safety arrow system includes a plurality of light emitting diodes (LEDs), an input switch for selecting the information to be displayed, a plurality of solid state switches, each solid state switch connected to one or more of the LEDs, a controller for reading the input switch and controlling the solid state switches to illuminated the LEDs to display the traffic control information, a battery for providing power to the traffic safety arrow system, a voltage controller for generating an operating voltage from the battery to operate the traffic safety arrow system, and an enclosure having at least two slots formed through its lower part to facilitate attachment of the traffic safety arrow system to a traffic barrel or a tripod.

### RELATED APPLICATIONS

This application claims priority to U.S. Provisional Application Ser. No. 60/969,797, filed Sep. 4, 2007, which is incorporated herein by reference.

### BACKGROUND

Traffic warning signs are found in many shapes and forms. For example, arrows that are reflective and/or illuminated may be used to direct traffic. Such arrow systems are typically mounted on the back of a vehicle and may include a trailer. Where construction is being performed upon or near a busy highway, traffic warning signs are often required to prevent traffic from moving down one or more lanes. The lanes to be voided of traffic are typically blocked by traffic cones and/or traffic barrels and traffic diverted to an adjacent lane. Several traffic arrows and signs are available for controlling traffic. For example, one type of traffic sign has a large illuminated and optionally flashing arrow mounted upon a trailer that may be towed behind a vehicle, such as a pick-up truck. Although large and visible, such signage has to be delivered to the construction site, setup, and configured for operation. Further, in view of the size of such a sign, its location in relation to the flow of traffic is often restricted.

For example, where a single lane of traffic is closed on a multi-lane highway, the closed lane is often blocked by traffic barrels to force vehicles to use an adjacent lane. However, approaching vehicles often fail to recognize the lane closure and available options for switching lanes, thereby posing a risk to construction workers and other vehicles. This problem is particularly acute where more than one lane is closed and the number of traffic barrels and traffic cones used is large. A driver in a low vehicle, for example, may be unable to conceptualize the lane closure and determine which way he is expected to turn.

### SUMMARY

In an embodiment, a traffic safety arrow system imparts traffic control information to traffic. The traffic safety arrow system includes a plurality of light emitting diodes (LEDs), an input switch for selecting the information to be displayed, a plurality of solid state switches, each solid state switch connected to one or more of the LEDs, a controller for reading the input switch and controlling the solid state switches to illuminated the LEDs to display the traffic control information, a battery for providing power to the traffic safety arrow system, a voltage controller for generating an operating voltage from the battery to operate the traffic safety arrow system, and an enclosure for housing the LEDs, the input switch, the solid state switches, the controller, the voltage controller and the battery, the enclosure having two slots formed through its lower part to facilitate attachment of the traffic safety arrow system to a traffic barrel.

In another embodiment, a traffic safety method imparts traffic control information to traffic in a construction zone. A traffic barrel is positioned to block traffic flow, the traffic barrel having disposed thereon a traffic safety arrow system. Switches on the traffic safety system are used to select one of a plurality of display sequences. If the switches have changed, a display sequence and a step period are determined, based upon the switches. If the switches have changed, the first step of the display sequence is displayed, and if the switches have not changed, a next step in the display sequence is displayed. The steps of determining and displaying are repeated until the traffic safety arrow system is turned off

In another embodiment, a traffic safety arrow system imparts traffic control information to traffic, including means for attaching the traffic safety arrow system to a traffic barrel, means for selecting the traffic control information for display on the traffic safety arrow system, means for displaying the traffic control information, and means for powering the traffic safety arrow system.

### BRIEF DESCRIPTION OF THE FIGURES

FIG. 1 is a schematic diagram illustrating one exemplary traffic safety arrow system, in an embodiment.

FIG. 2 shows a front view of a traffic safety arrow system, based upon the traffic arrow system of FIG. 1.

FIG. 3 is a cross-sectional view of the system of FIG. 2.

FIG. 4 shows a conventional traffic barrel of the type used by road construction crews to channel traffic away from an area when road repairs are being made.

FIGS. 5A and 5B show rear and front views, respectively, of the system of FIG. 2 mounted to the barrel of FIG. 4.

FIG. 6 shows one exemplary light emitting diode (LED) display sequence (A-G) for displaying a running left arrow on the system of FIG. 2.

FIG. 7 shows one exemplary LED display sequence for displaying a running right arrow on the system of FIG. 2.

FIG. 8 shows one exemplary display sequence for displaying bi-directional running arrows on the system of FIG. 2.

FIG. 9 shows one exemplary display sequence for displaying a flashing cross on the system of FIG. 2.

FIG. 10 shows one exemplary LED layout of fifty-five LEDs that allows the word ‘SLOW’ to be displayed.

FIG. 11 shows one exemplary display sequence of a flashing ‘SLOW’ sign using the layout of FIG. 10.

FIG. 12 shows one exemplary display sequence of a moving left arrow using the layout of FIG. 10.

FIG. 13 shows one exemplary display sequence of a moving right arrow using the layout of FIG. 10.

FIG. 14 is a flowchart illustrating one exemplary process for displaying traffic safety signals.

FIG. 15 shows one exemplary system embodiment, similar to the system embodiment of FIGS. 2 and 3.

FIG. 16 shows an exemplary cross-section of the embodiment of FIG. 15.

FIGS. 17 and 18 show an alternate embodiment of the traffic safety arrow system of FIG. 2.

FIG. 19A is a schematic diagram illustrating one exemplary traffic safety arrow system, in an embodiment.

FIG. 19B shows a front view of a traffic safety arrow system of FIG. 19A.

FIG. 20 shows one exemplary LED layout that allows the words ‘ROAD CLOSED’ to be displayed.

FIG. 21 shows one exemplary LED layout that allows the word ‘MERGE’ to be displayed.

FIG. 22 shows one exemplary light emitting diode (LED) display sequence (A-B) for displaying a flashing right arrow and the word ‘EXIT’ to be displayed on the system of FIG. 2.

FIG. 23 shows one exemplary light emitting diode (LED) display sequence (A-C) for displaying a running phrase ‘WORK ZONE AHEAD’ to be displayed on the system of FIG. 2.

FIG. 24 shows one exemplary light emitting diode (LED) display sequence (A-C) for displaying a flashing right arrow and a flashing left arrow and the word ‘SIDEWALK CLOSED’ to be displayed on the system of FIG. 2

FIG. 25 shows one exemplary light emitting diode (LED) display sequence (A-C) for displaying a running phrase ‘POLICE CHECK POINT’ and stationary arrows to be displayed on the system of FIG. 2

FIG. 26 shows one exemplary light emitting diode (LED) display sequence (A-C) for displaying a phrase ‘SPEED LIMIT 20 MPH’ to be displayed on the system of FIG. 2.

FIG. 27 shows one exemplary representation of a walking pedestrian sign to be displayed on the system of FIG. 2.

FIG. 28 shows a tripod capable of displaying the system of FIG. 2.

FIGS. 29A and 29B show rear and front views, respectively, of the system of FIG. 2 mounted to a tripod.

FIGS. 30A, 30B, 30C and 30D show an exemplary layout of LEDs formed to display a double headed arrow, a cross, a left arrow, and a right arrow, in an embodiment.

FIG. 31 shows one exemplary set of buttons for controlling the traffic safety arrow systems of FIGS. 1 and 2.

FIG. 32 shows an exemplary remote control 3200 for controlling operation of a traffic arrow system (e.g., system 100, FIG. 1, and system 200, FIG. 2) from a remote location.

FIG. 33 shows an exemplary remote control device 3300 for controlling a traffic safety arrow system (e.g., system 100, FIG. 1, system 200, FIG. 2, system 1900, FIG. 19A, and system 1950, FIG. 19B).

FIG. 34 shows one exemplary display of the traffic safety arrow systems of FIGS. 1 and 2.

FIG. 35 shows exemplary frames of the display of FIG. 34.

### DETAILED DESCRIPTION OF THE FIGURES

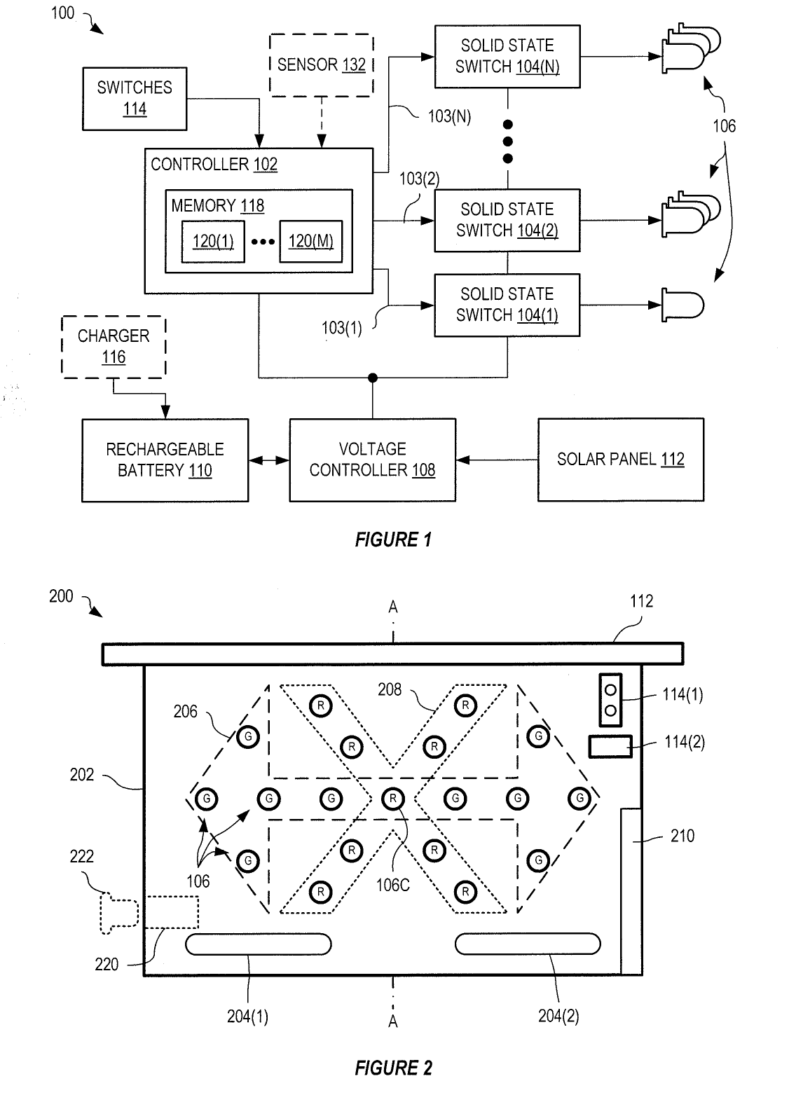

FIG. 1 is a block diagram illustrating an exemplary traffic safety arrow system 100. System 100 has a controller 102, a plurality of solid state switches 104, a plurality of high intensity light emitting diodes (LEDs) 106, a voltage controller 108, a rechargeable battery 110, a solar panel 112 and a plurality of switches 114. Rechargeable battery 110 is connected to voltage controller 108 that operates to charge battery 110 from power received from solar panel 112 and to condition power received from solar panel 112 and/or battery 110 for use by other components of system 100, such as controller 102, solid state switches 104, and LEDs 106. In one embodiment, voltage controller 108 generates one voltage for controller 102 and a second voltage for solid state switches 104 and LEDs 106. Even when system 100 is turned off, voltage controller 108 may operate to charge rechargeable battery 110 when sufficient solar radiation is incident upon solar panel 112. Controller 102 receives input from switches 114 to select one or more display sequences 120 stored within a memory 118 of controller 102. Memory 118 may be external to controller 102 without departing from the scope hereof. Based upon the selected display sequence 120, controller 102 outputs one or more control signals 103 to solid state switches 104. Each solid state switch 104 is operable to drive one or more LEDs 106 to emit light. Controller 102 thereby controls illumination of LEDs 106 via solid state switches 104 and control signals 103. For example, controller 102 uses control signal 103(1) to control solid state switch 104(1) to operate one or more LEDs 106 connected to solid state switch 104(1).

Optionally, a charger 116 may be used to charge battery 110 from an alternate power source, such as a household power outlet or a vehicle 12 volt outlet. In one embodiment, charger 116 is a separate unit that connects to battery 110 via an external connector.

Each solid state switch 104 may include one or more transistors for controlling current to one or more LEDs 106.

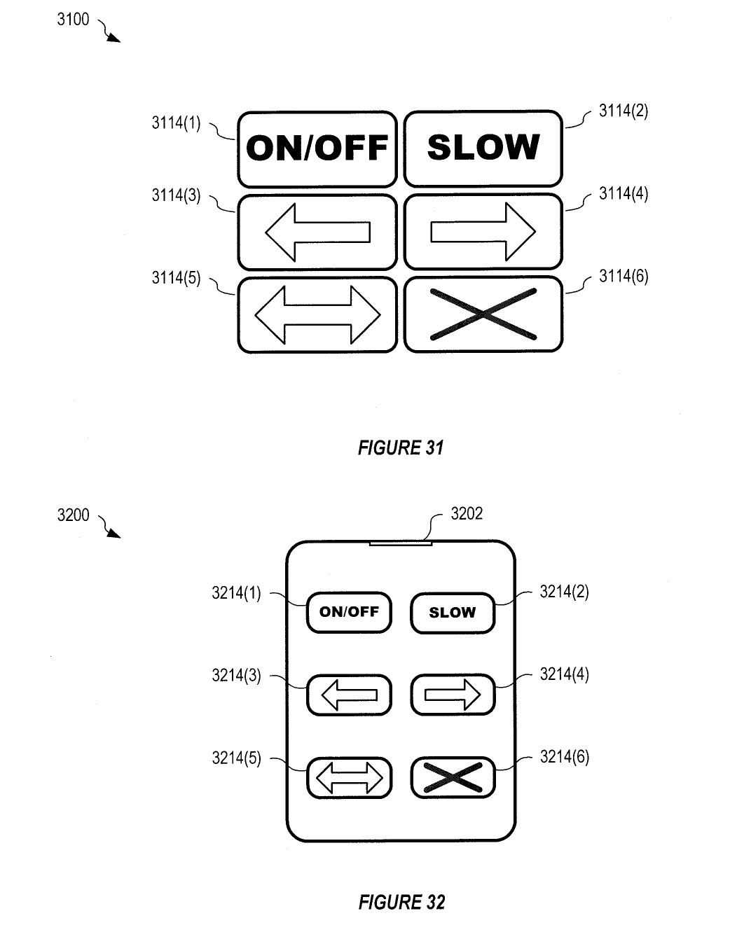

FIG. 2 shows a front view of a traffic safety arrow system 200. System 200 is based upon system 100 of FIG. 1 and is shown within an enclosure 202 that is mountable upon a traffic barrel or other such traffic controlling device. Enclosure 202 may be waterproof and configured with a plastic screen at the font that is transparent to light emitted by LEDs 106. LEDs 106 may be mounted upon a printed circuit board within enclosure 202. As shown, certain of LEDs 106 may be arranged in the shape of a double headed arrow 206. Some such LEDs 106 are green and shown to be marked with a “G” in FIG. 2. Other LEDs 106 emit red light when activated and are arranged in the form of a cross 208, and each of these LEDs 106 are shown to be marked with the letter “R.” LED 106C is shown to be located within double headed arrow 206, and within cross 208, and may be selected as a green emitting LED or a red emitting LED as is shown. Optionally, LED 106C may be selected as a bicolor LED that is capable of emitting both green and red light under control of controller 102. Switches 114 are shown mounted within enclosure 202 such that they are operable from the front face of enclosure 202. Switches 114 are shown as two groups or units 114(1) and 114(2). However, more or less units, each with one or more switches, may be used without departing from the scope hereof. See exemplary switches 3100 of FIG. 31, for example. Switches 114 may also be waterproof, thereby maintaining the waterproof integrity of enclosure 202. Switches 114 may be selected as one or more of toggle, push-button, slide, recessed, etc.

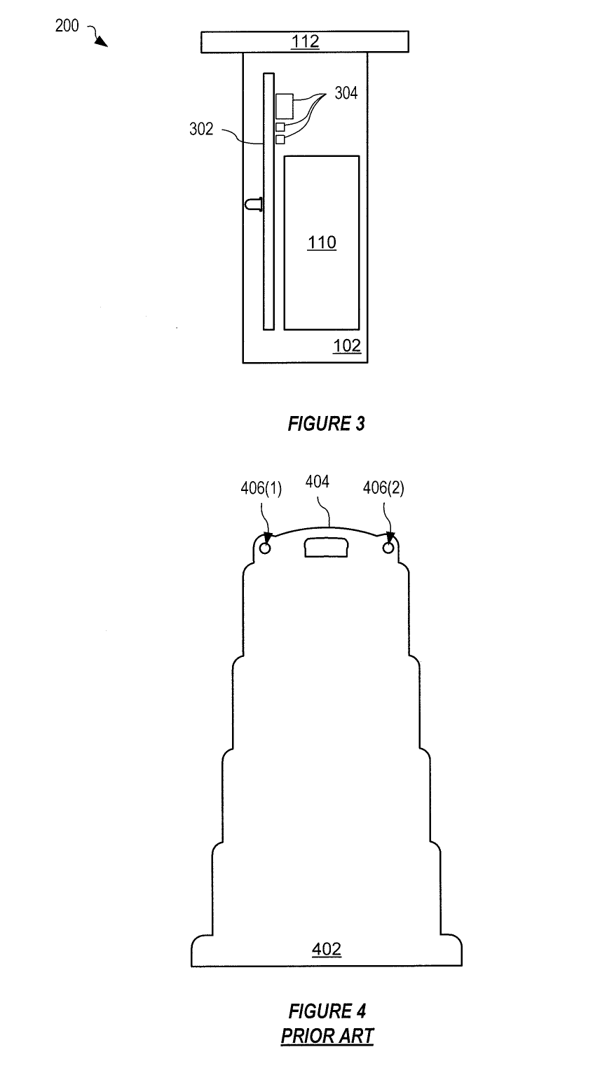

Enclosure 202 has two mounting holes 204(1) and 204(2) that facilitate mounting of enclosure 202 to a traffic barrel as shown in FIGS. 3A and 3B. Mounting holes 204 are elongated in a horizontal direction to accommodate a wide range of mounting widths. Mounting holes 204 are in effect watertight tubes that pass through enclosure 202 thereby maintaining the waterproof integrity of enclosure 202.

Enclosure 202 is also shown with a battery door 210 on one end that facilitates installation and removal of battery 110. Door 210 may be designed to maintain the waterproof integrity of enclosure 202. Door 210 may be attached by one or more screws, or by a keyed fit and latch mechanism, to enclosure 202.

Solar panel 112 is shown mounted on the top of enclosure 202. In one example, solar panel 112 forms a lid of enclosure 202 to maintain waterproof integrity of enclosure 202. Solar panel 112 may be designed and sized to provide sufficient power to maintain operation of system 200 over an extended period. That is, system 200 may operate from solar power alone.

In an alternate embodiment, a socket 220 is incorporated into enclosure 202 to facilitate charging of rechargeable battery 110. Charger 116 is, for example, incorporated within enclosure 202 and socket 220 to allow connection of a 110V AC power supply to charger 116. Alternatively, charger 116 may be designed to connect to a 110V AC power source and connect to rechargeable battery 116 via a plug that mates with socket 220.

A watertight plug may also be included with socket 220 to maintain waterproof integrity of enclosure 202 when rechargeable battery 110 is not being charged.

FIG. 3 is a cross-sectional view 300 as seen through cross section A-A of system 200, shown in FIG. 2. In particular, FIG. 3 shows enclosure 102 and solar panel 112 forming a waterproof volume containing battery 110 and a circuit board 302. Circuit board 302 is populated with LEDs 106 (shown with LED 106C) and other components 304 that represent electrical components of one or more of controller 102, solid state switches 104, and voltage controller 108 of system 100, FIG. 1.

FIG. 4 shows a conventional traffic barrel 402 of the type used by road construction crews to channel traffic away from an area when road repairs are being made. In particular, barrel 402 has a handle 404 for carrying barrel 402 and two mounting holes 406(1) and 406(2) that facilitate mounting of traffic beacons (not shown) to barrel 402. Barrel 402 may include one or more reflective bands and is typically bright orange in color.

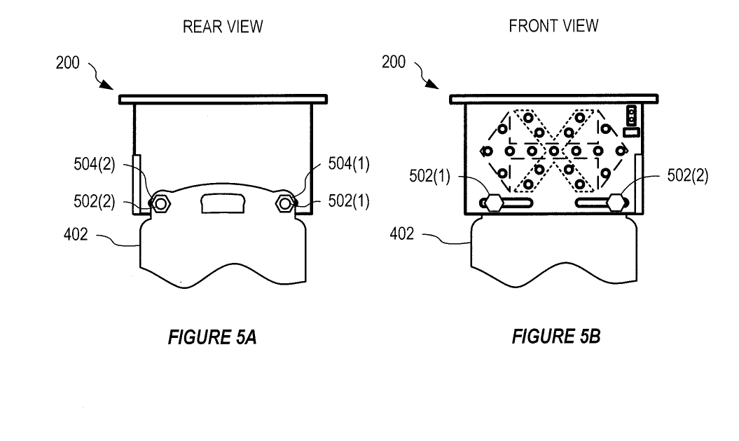

FIGS. 5A and 5B show rear and front views, respectively, of system 200, FIG. 2, mounted to barrel 402, FIG. 4, by two non-metal (e.g., nylon or other plastic material) bolts 502(l), 502(2) and two non-metal (e.g., nylon or other plastic material) nuts 504(1) and 504(2). Bolt 502(1) passes through slot 204(1) of system 200, hole 406(1) of barrel 402 and is secured by nut 504(1). Similarly, bolt 502(2) passes through slot 204(2) of system 200, hole 406(2) of barrel 402 and is secured by nut 504(2). Slots 204 of system 200 facilitate attachment of system 200 to barrels and other units with varying mounting hole positions.

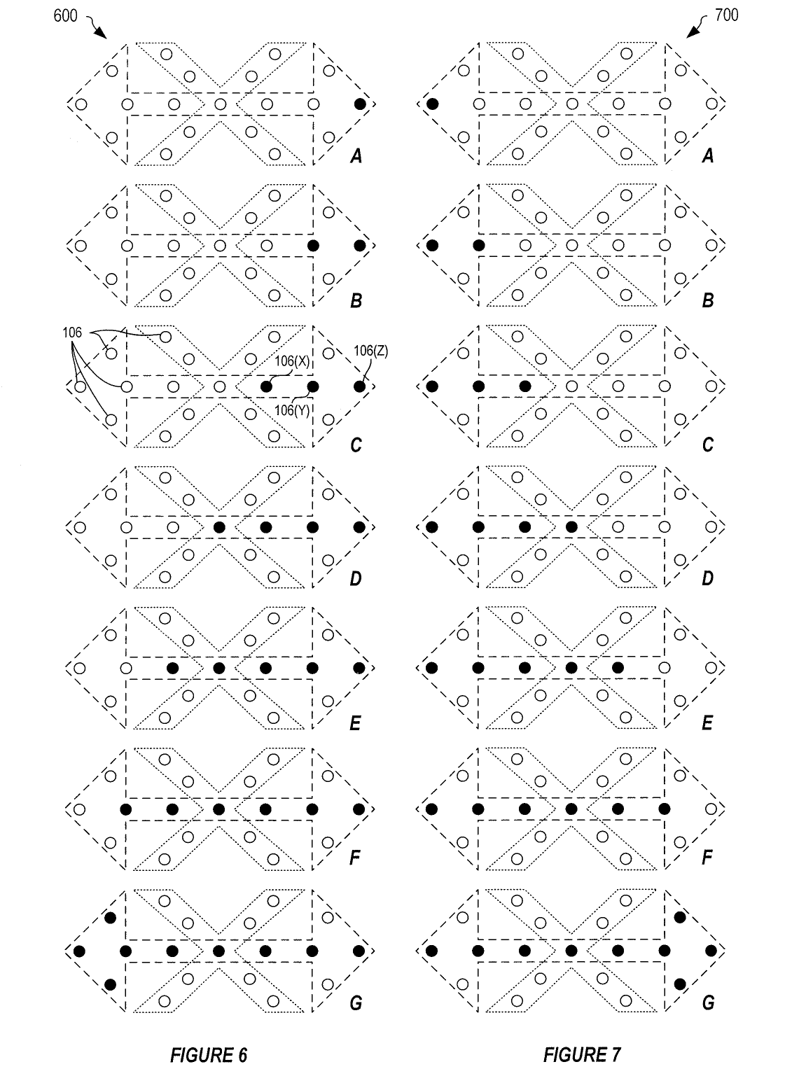

FIG. 6 shows one exemplary LED 106 display sequence 600 (A-G) for displaying a running left arrow on system 200, FIG. 2. FIG. 7 shown one exemplary LED 106 display sequence 700 (A-G) for displaying a running right arrow on system 200. Display sequences 600 and 700 may each represent one of display sequences 120, FIG. 1. Each sequence 600 and 700 repeats until a different display is selected or system 200 is turned off. In one example of operation, a user turns on system 200 and selects the running left arrow using switches 114. Controller 102 controls solid state switches 104 to illuminate the appropriate LEDs 106 for each step (A-G) of sequence 600, each step lasting for half a second, for example.

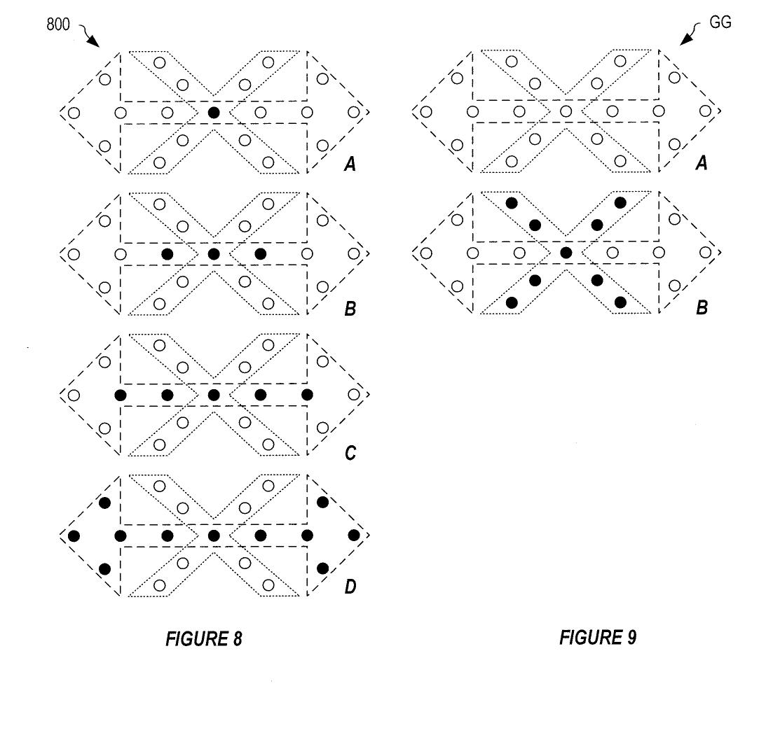

FIG. 8 shows one exemplary display sequence 800 (A-D) for displaying bi-directional running arrows on system 200. Display sequences 800 may represent one of display sequences 120, FIG. 1. Sequence A-D may repeat until a different display is selected or system 200 is switched off. In one example of operation, the user selects bi-directional running arrows and turns system 200 on using switches 114. Controller 102 controls solid state switches 104 to illuminate the appropriate LEDs 106 for each step (A-D) of sequence 800, each step lasting for half a second, for example.

FIG. 9 shows one exemplary display sequence 900 (A-B) for displaying a flashing cross on system 200. Display sequences 900 may represent one of display sequences 120, FIG. 1. Sequence A-B may repeat until a different display is selected or system 200 is switched off. In one example of operation, the user selects flashing cross and turns system 200 on using switches 114. Controller 102 controls solid state switches 104 to illuminate the appropriate LEDs 106 for each step (A-B) of sequence 900, each step lasting for half a second, for example.

The duration between steps of each sequence 600, 700, 800 and 900 may also be configured to meet traffic control regulations. Further, controller 102 may control solid state switches 104, using a pulse width modulation technique, to control the brightness of LEDs 106 when illuminated. Optionally, system 200 may include a light sensor that is used by controller 102 to determine ambient lighting levels and also thereby control the brightness at which LEDs 106 are illuminated. At night, LEDs 106 may be illuminated to a lower level as compared to a daytime illumination level, thereby reducing power drain from battery 110 at night when no solar energy is available.

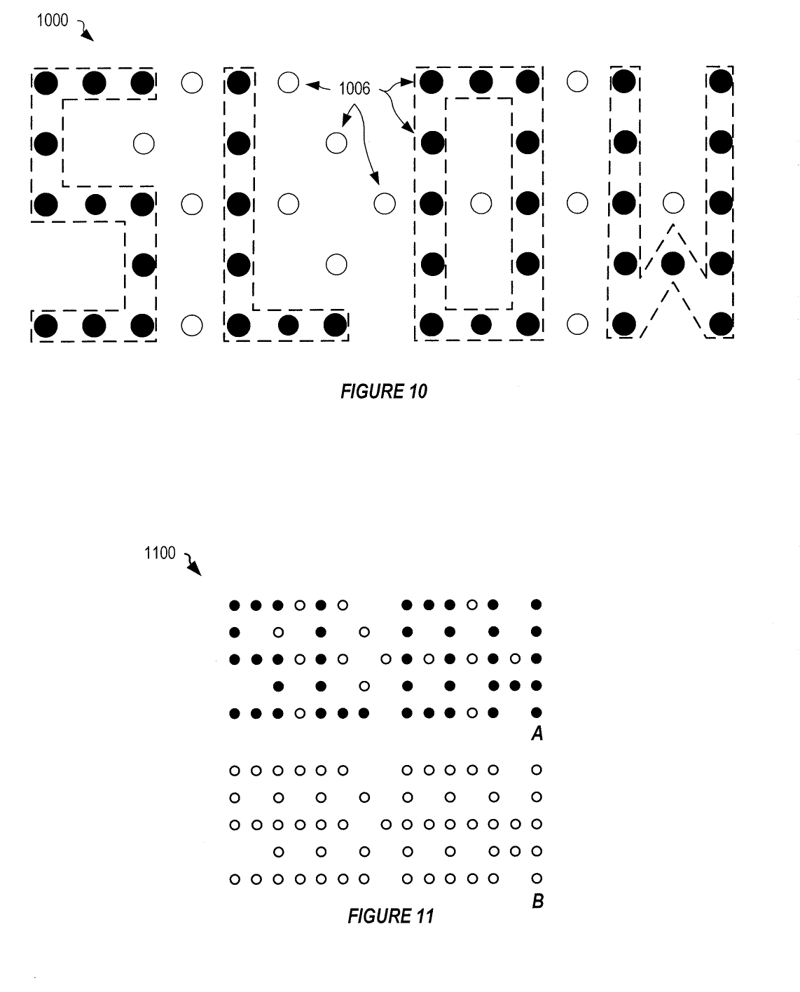

In an alternate embodiment of system 200, FIG. 10 shows one exemplary LED layout 1000 of fifty-five LEDs 1006 that display the word “SLOW” while maintaining the aforementioned features of system 200. In particular, layout 1000 has fifty-five LEDs (36 more than the example shown in FIG. 2) that provide functionality of system 200 and its display with additional clarity, as described hereinbelow. In the example of FIG. 10, fourteen LEDs 1006 are not illuminated when displaying the word “SLOW.”

FIG. 11 shows one exemplary display sequence 1100 (A-B) for displaying a flashing “SLOW” sign. Display sequences 1100 may represent one of display sequences 120, FIG. 1. Each step of sequence 1100 may be displayed for a defined period (e.g., half of one second), the sequence repeating until an alternate display sequence 120 is selected or system 200 is turned off. In one embodiment, controller 102 operates to fade the word “SLOW” in and out rather than having a step change.

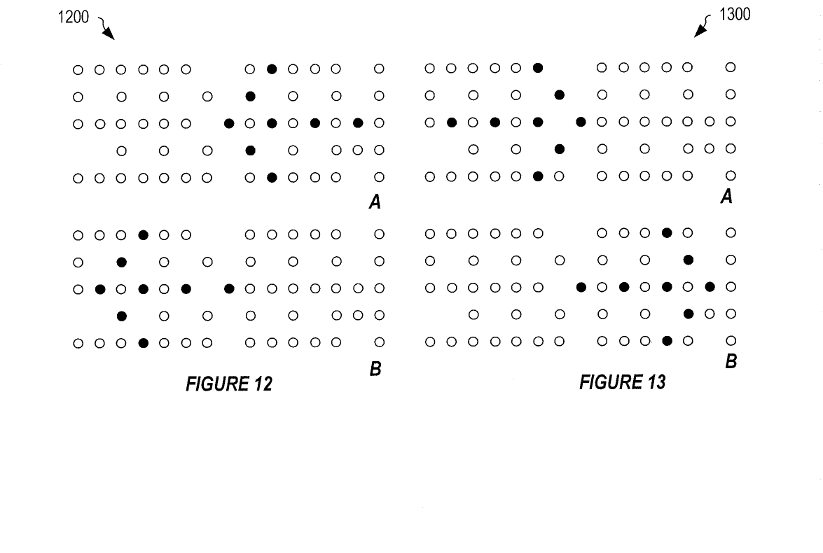

FIG. 12 shows one exemplary display sequence 1200 (A-B) for displaying a moving left arrow. Similarly, FIG. 13 shows one exemplary display sequence 1300 (A-B) for displaying a moving right arrow. Display sequences 1200 and 1300 may each represent one of display sequences 120, FIG. 1.

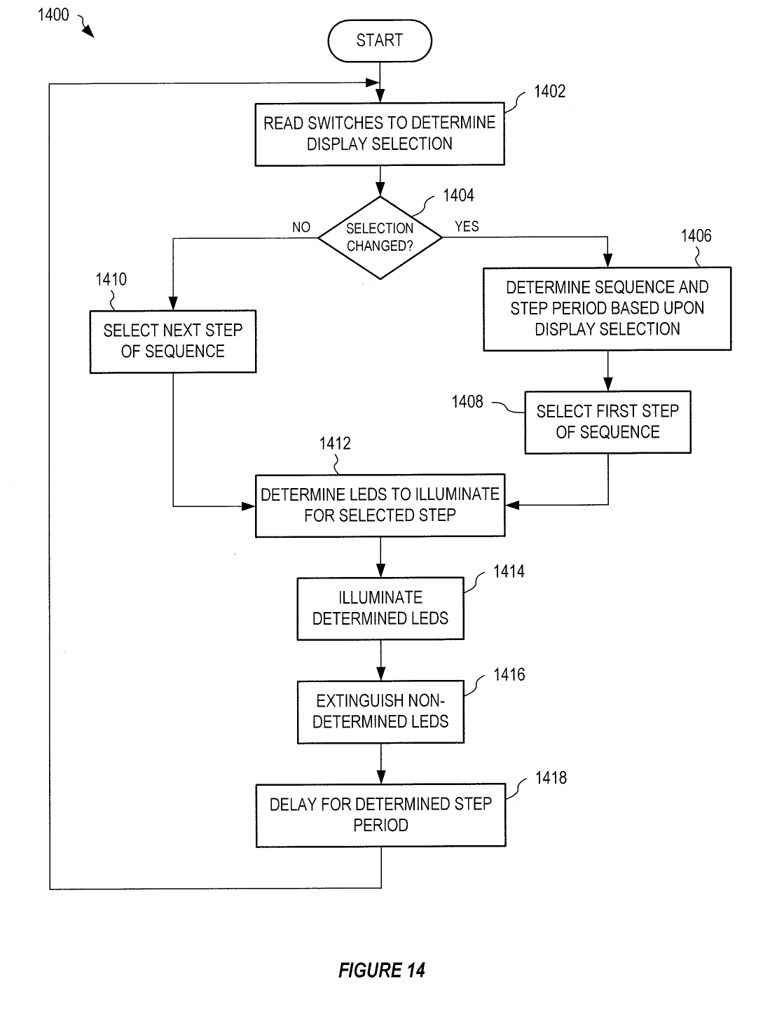

FIG. 14 is a flowchart illustrating one exemplary process 1400 for displaying traffic safety signals. Process 1400 is for example implemented by or within controller 102 of system 100, FIG. 1.

In step 1402, process 1400 reads switches to determine the selected display selection. In one example of step 1402, controller 102 reads switches 114 to determine which of display sequences 120 is selected. Step 1404 is a decision. If, in step 1404, process 1400 determines that the display selection has changed from the previous execution of step 1402, process 1400 continues with step 1406; otherwise process 1400 continues with step 1410.

In step 1406, process 1400 determines the LED illumination sequence and the step period based upon the display selection determined in step 1402. In one example of step 1406, controller 102 reads a selected display sequence 120 from memory 118 and determines a suitable step period. In step 1408, process 1400 selects the first step of the determined sequence. In one example of step 1408, controller 102 selects step A of display sequence 600, FIG. 6, where display sequence 600 has been selected in step 1402. Process 1400 then continues from step 1408 to step 1412.

In step 1410, process 1400 selects a next step of the current sequence. In one example of step 1410, controller 102 selects step A of display sequence 1200, FIG. 12, where step B is the current step.

In step 1412, process 1400 determines which LEDs 106 (or 1006) may be illuminated for the selected step. In one example of step 1412, controller 102 determines that LEDs 106(X), 106(Y) and 106(Z) of LEDs 106 are to be illuminated in step C of display sequence 600. In step 1414, process 1400 illuminated these determined LEDs. In one example of step 1414, controller 102 generates one of more signals 103 to activate one or more solid state switches 104 to illuminate LEDs 106(X), 106(Y) and 106(Z). In step 1416, process 1400 extinguishes LEDs determined not to be illuminated. In one example of step 1416, controller 102 deactivates certain of signals 103 to turn off certain solid state switches connected to LEDs 106 that are not to be illuminated. In step 1418, process 1400 waits for the determined step period before proceeding with step 1402. In one example of step 1418, controller 102 sets an internal timer to awaken the controller after a defined period of the step, and then may put itself to sleep to conserve battery power.

Steps 1402-1418 repeat until system 200 is turned off.

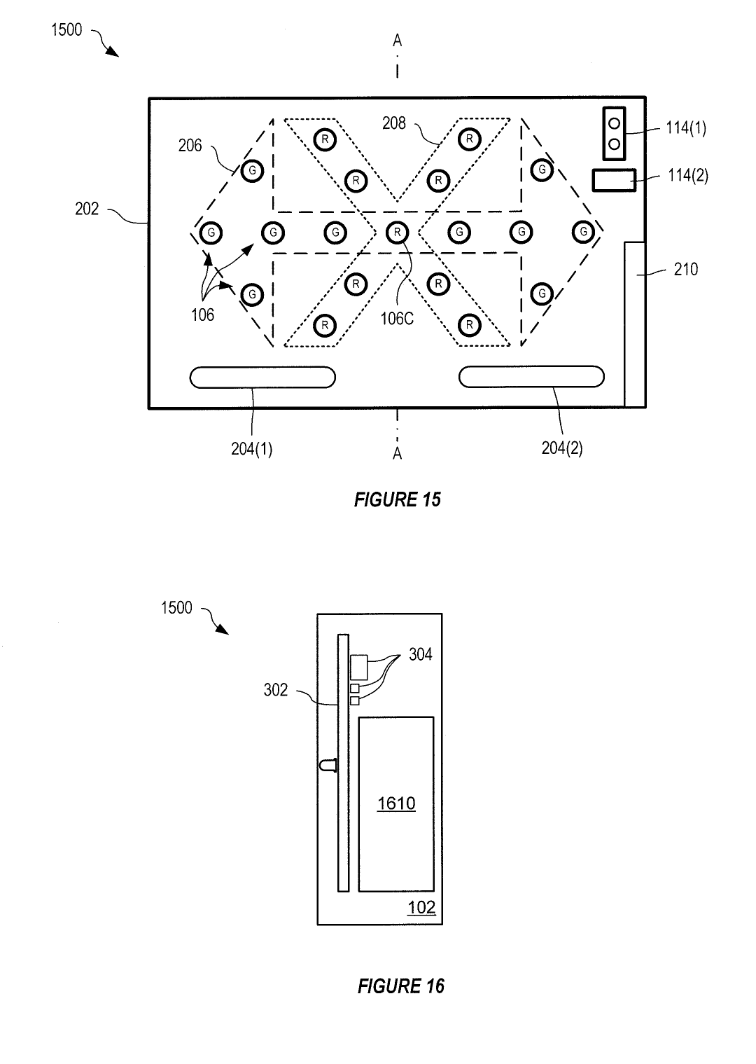

FIG. 15 and FIG. 16 show one exemplary system embodiment 1500 that is similar to system embodiment 200 of FIGS. 2 and 3, except that, in this example, system 1500 is not shown to include a solar panel or a rechargeable battery. System 1500 may include a consumable battery 1610 that may be replaced, through use of battery door 210, when exhausted. Battery 1610 may be formed from a plurality of consumable cells, such as alkali D-cells, thereby making battery replacement convenient.

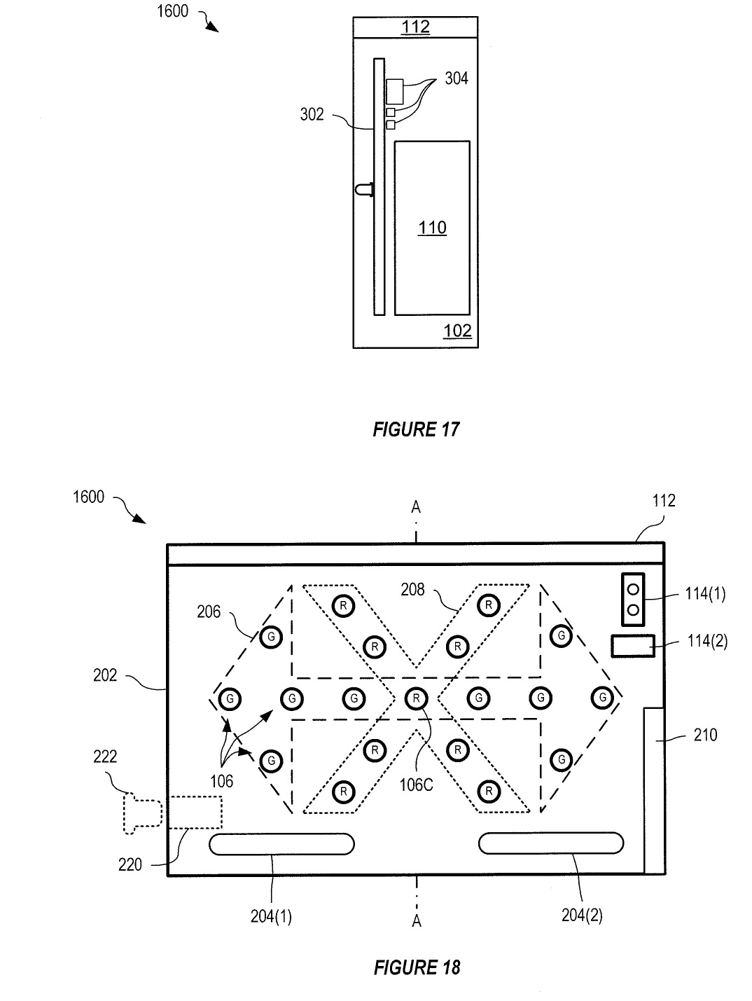

FIGS. 17 and 18 show a side view and a rear view, respectively, of an alternate system 1600 embodiment of traffic safety arrow system 200 of FIG. 2. In this example, the solar panel may be sized to be the same as the top surface of the enclosure. In other words, system 1600 is similar to system 200, except that solar panel 116 may be designed to not extend beyond the edges of enclosure 202. Conversely, where a certain size is required for solar panel 116, enclosure 202 may be sized accordingly.

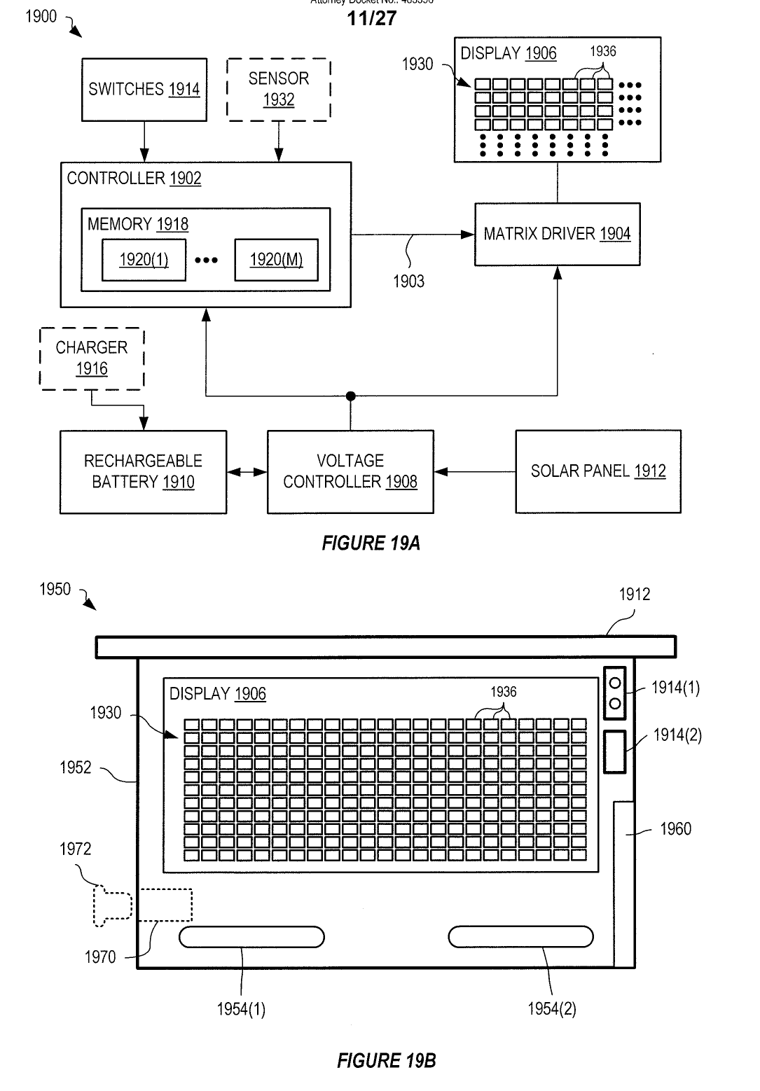

FIG. 19A is a block diagram illustrating one exemplary traffic safety arrow system 1900. In this example, system 1900 is similar to system 100 of FIG. 1, but may have an alternate display format. System 1900 has a controller 1902, a matrix driver 1904, a matrix based display 1906, a voltage controller 1908, a rechargeable battery 1910, a solar panel 1912, and a plurality of switches 1914. Rechargeable battery 1910 is connected to voltage controller 1908 that operates to charge battery 1910 from power received from solar panel 1912, and to condition power received from solar panel 1912 and/or battery 1910 for use by other components of system 1900, such as controller 1902, matrix driver 1904, and display 1906. In one embodiment, voltage controller 1908 generates one voltage for controller 1902 and a second voltage for matrix driver 1904 and display 1906. Even when system 1900 is turned off, voltage controller 1908 may operate to charge rechargeable battery 1910 when sufficient solar radiation is incident upon solar panel 1912. Controller 1902 receives input from switches 1914 to select one or more display sequences 1920 stored within a memory 1918 of controller 1902. Memory 1918 may be external to controller 1902 without departing from the scope hereof. Based upon the selected display sequence 1920, controller 1902 outputs one or more control signals 1903 to matrix driver 1904. Matrix driver 1904 is operable to drive one or more elements of display 1906 to emit light. Controller 1902 may thereby control illumination of display 1906 via matrix driver 1904 and control signals 1903. For example, controller 1902 uses control signal 1903 to control matrix driver 1904 to operate one or more elements of display 1906. In one example, controller 1902 utilizes control signal 1903 to operate matrix driver 1904 to control brightness of light output by display 1906 by utilizing a pulse width modulation technique (known in the art) to vary intensity (of time) of active elements of display 1906. The control of light output levels (i.e., brightness) may reduce power requirements for operation of system 1900, thereby extending its operational duration.

Optionally, a charger 1916 may be used to charge battery 1910 from an alternate power source, such as a household power outlet or a vehicle 12 volt outlet. In one embodiment, charger 1916 is a separate unit that connects to battery 1910 via an external connector.

Matrix driver 1904 may include one or more of transistors (e.g., similar to solid state switches 104 of system 100, FIG. 1), field-programmable gate arrays (FPGAs), and other current control devices, for controlling current to activate one or more display elements of display 1906 under control of controller 1902.

Optionally, system 1900 may include one or more sensors 1932 to sense ambient conditions, such as ambient light levels. Controller 1902 may receive ambient light information from sensor 1932 and thereby determine a desired brightness of display 1906.

Display 1906 is shown as an array 1930 of light emitting elements 1936, and may include two or more same or different sized arrays without departing from the scope hereof. In particular, the size of the one or more arrays 1930 and type of light emitting elements 1936 may be selected based upon a specific application of traffic safety arrow 1900. In one embodiment, array 1930 represents an organic light emitting diode (OLED) device having a plurality of OLED elements formed as an array. Where display 1906 has a large number of light emitting elements, these elements may be grouped to provide a reduced number of logical light emitting elements to facilitate control of display 1906. Alternatively, higher resolution character and graphic displays may be generated by display 1906. For example, the use of OLED based displays may allow system 1900 to display highly legible instructions for motorists and pedestrians.

FIG. 19B shows a front view of a traffic safety arrow system 1950 that is based upon system 1900 of FIG. 19A, and is shown within an enclosure 1952 that is mountable upon a traffic barrel or other such traffic controlling device. Enclosure 1952 may be waterproof and configured with a plastic screen at the front that is transparent to light emitted by display 1906. Display 1906 is, for example, mounted upon a printed circuit board within enclosure 1952. As shown in FIG. 19B, display 1906 is formed as array 1930 having 23 columns by 11 rows of light emitting elements 1936.

Switches 1914 are shown mounted within enclosure 1952 such that they are operable from the front face of enclosure 1952. Switches 1914 are shown as two groups or units 1914(1) and 1914(2). However, more or fewer units, each with one or more switches, may be used without departing from the scope hereof. Switches 1914 may also be waterproof, thereby maintaining the waterproof integrity of enclosure 1952. Switches 1914 may be selected as one or more of toggle, push-button, slide, recessed, etc.

Enclosure 1952 has two mounting holes 1954(1) and 1954(2) that facilitate mounting of enclosure 1952 to a traffic barrel (similar to the mounting of enclosure 202 of FIGS. 3A and 3B). Mounting holes 1954 are elongated in a horizontal direction to accommodate a wide range of mounting widths. Mounting holes 1954 may be, in effect, watertight tubes that pass through enclosure 1952 thereby maintaining the waterproof integrity of enclosure 1952.

Enclosure 1952 is also shown with a battery door 1960 on one end that facilitates installation and removal of battery 1910. Door 1960 may be designed to maintain the waterproof integrity of enclosure 1952. Door 1960 may be attached by one or more screws, or by a keyed fit and latch mechanism, to enclosure 1952.

Solar panel 1912 is shown mounted on the top of enclosure 1952. In one example, solar panel 1912 forms a lid of enclosure 1952 to maintain waterproof integrity of enclosure 1952. Solar panel 1912 may be designed and sized to provide sufficient power to maintain operation of system 9100 over an extended period. That is, system 1900 may operate from solar power alone.

In an alternate embodiment, a socket 1970 is incorporated into enclosure 1952 to facilitate charging of rechargeable battery 1910. Charger 1916 is for example incorporated within enclosure 1952 and socket 1970 to allow connection of a 110V AC power supply to charger 1916. Alternatively, charger 1916 may be designed to connect to a 110V AC power source and connect to rechargeable battery 1916 via a plug that mates with socket 1970.

A watertight plug may also be included with socket 1970 to maintain waterproof integrity of enclosure 1952 when rechargeable battery 1910 is not being charged.

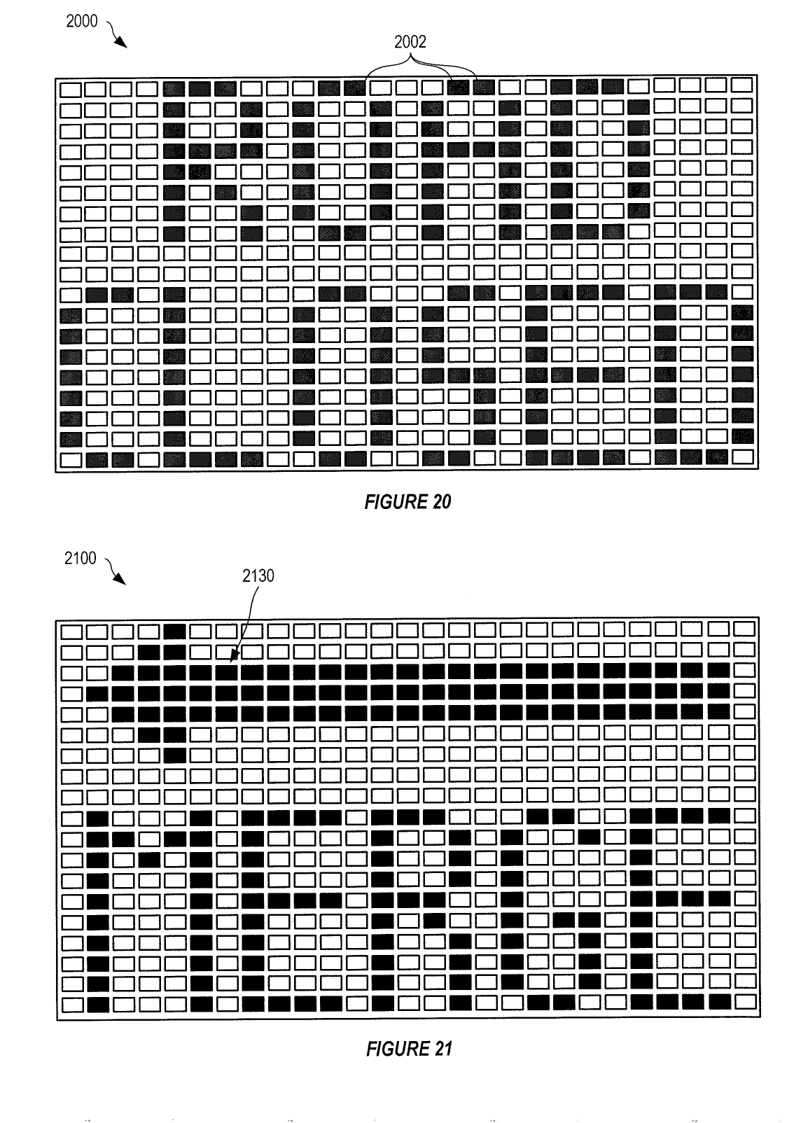

Exemplary configurations for display 1906 of systems 1900 and 1950 are shown in certain of the following figures. In an embodiment, display 1906 has sufficient resolution (i.e., sufficient columns and rows of light emitting elements) to display all exemplary frames of FIGS. 20-30. In alternate embodiments, one or more displays 1906 are configured to display only a selection of frames of FIGS. 20-30. In certain embodiments, display 1906 is animated in that a sequence of frames are displayed at predetermined time intervals to allow more information to be imparted to drivers and pedestrians than can be shown at any one time on display 1906.

FIG. 20 shows one exemplary frame 2000 of display 1906 implemented with an array of rectangular light emitting elements having 27 columns by 19 rows and forming the text “ROAD CLOSED.” In an embodiment, illuminated light emitting elements 2002 intermittently flash off and on heighten awareness of the displayed information.

FIG. 21 shows another exemplary frame 2100 of display 1906 implemented with an array of light emitting elements (e.g., array 1930, FIGS. 19A, 19B) having 27 columns by 19 rows and forming the word “MERGE” and showing an arrow 2130. In one embodiment, arrow 2130 may be flashing to attract the attention of approaching drivers.

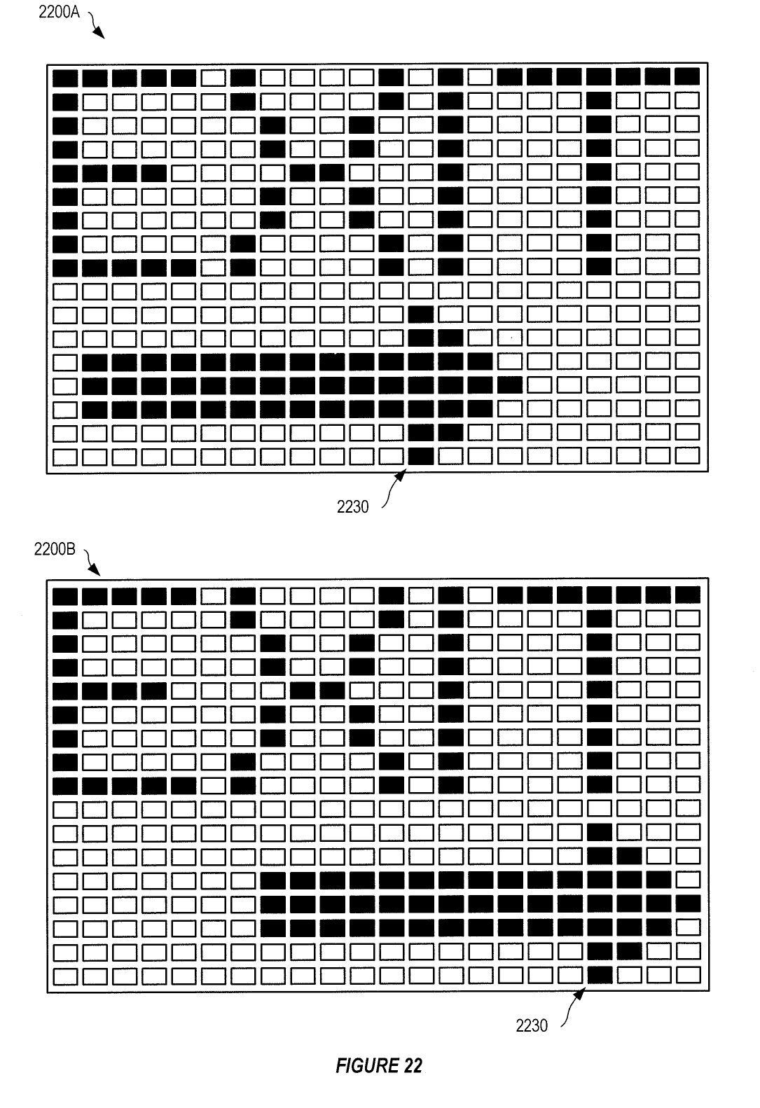

FIG. 22 shows two exemplary frames 2200A and 2200B of a display sequence by an array of light emitting elements (e.g., array 1930, FIGS. 19A, 19B) having 22 columns by 17 rows that are selectively illuminated to form the word “EXIT” and a moving right arrow 2230. Only two frames, of a possible 22 frame sequence (e.g., arrow 2230 moving one pixel to the right in each successive frame and wrapping to reappear on the left side of the display) are shown in this example. Alternately, arrow 2230 may be static, or may be intermittently displayed (i.e., flashing) to attract the attention of approaching drivers and pedestrians.

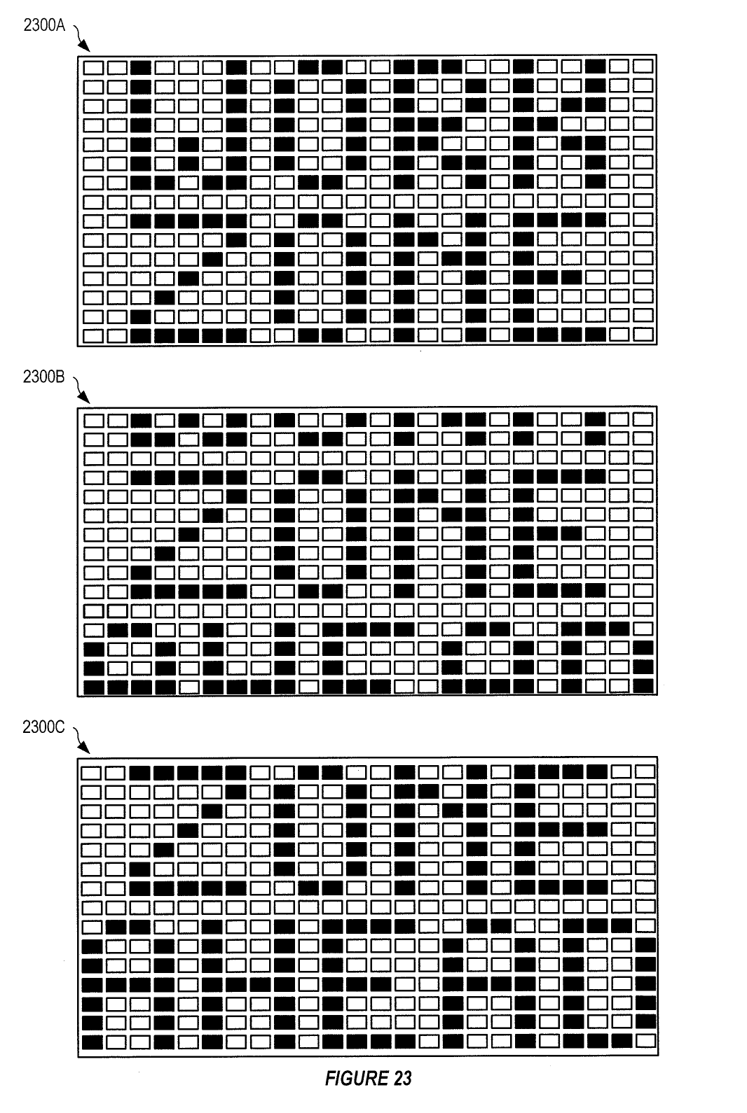

FIG. 23 shows three exemplary frames 2300A, 2300B, and 2300C of a display sequence by an array of light emitting elements (e.g., array 1930, FIGS. 19A, 19B) having 24 columns by 15 rows and forming the words “WORK ZONE AHEAD.” Only three frames of a possible eight frame sequence of vertical scrolling text are shown. Frames 2300A and 2300C are main frames of the sequence and may display for a longer duration than intermediate frames (e.g., frame 2300B). For example, the duration between frames may be controlled by controller 1902 to meet traffic control regulations and for optimum viewing. In an alternate embodiment, only frames 2300A and 2300C are displayed (i.e., animated smooth scrolling is not performed) alternately for an appropriate amount of time.

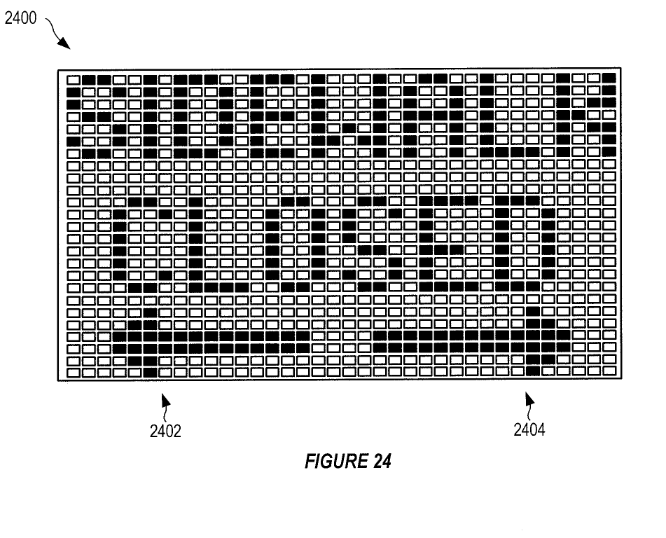

FIG. 24 shows one exemplary frame 2400 for display on an array of light emitting elements having 36 columns by 25 rows selectively illuminated to display the words “SIDEWALK CLOSED” and arrows 2402 and 2404. Arrows 2402 and 2404 may be omitted, or when displayed, may be intermittently activated (i.e., flashed).

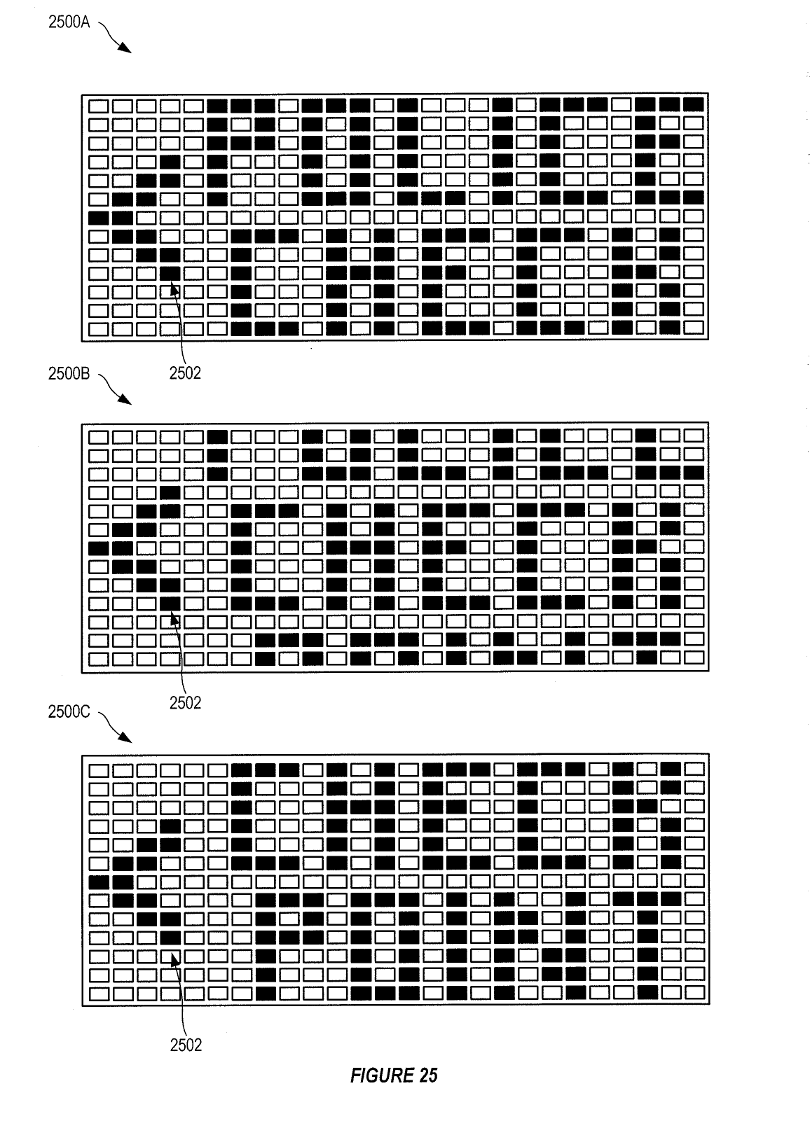

FIG. 25 shows three exemplary frames 2500A, 2500B, and 2500C of a possible eight-frame display sequence for display on an array of light emitting element having 26 column by 13 row, selectively illuminated to display the vertically scrolling words “POLICE CHECK POINT” and a stationary left arrow 2502. That is, left arrow 2502 remains stationary while the displayed text scrolls.

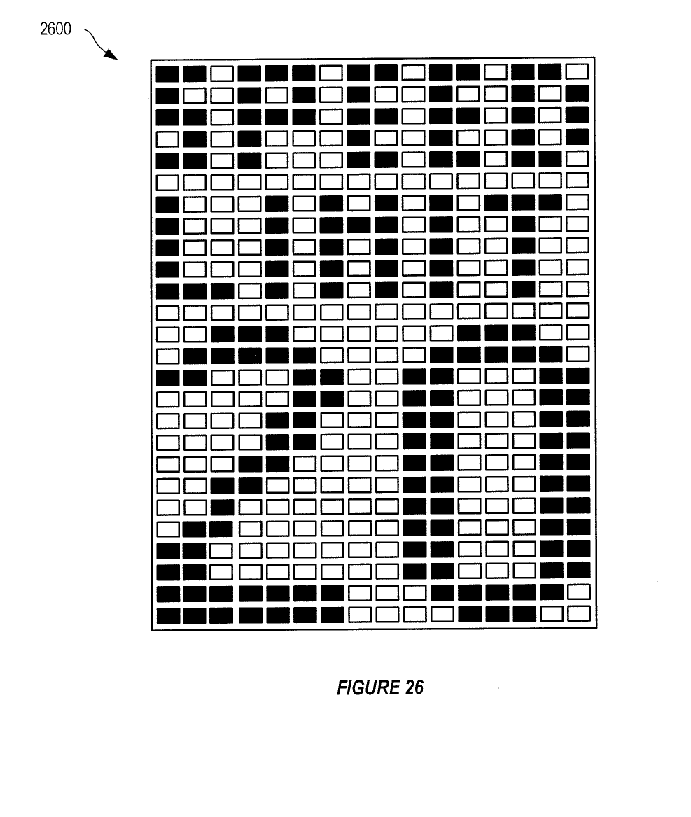

FIG. 26 shows one exemplary frame 2600 for display on an array of light emitting elements having 16 columns by 26 rows of selectively illuminated to display the words “SPEED LIMIT” and the number twenty. In an embodiment, the speed limit may be selected through use of switches 1914 (e.g., a thumbwheel switch allowing the selection of the speed limit in 5 value intervals) once the speed limit display is selected.

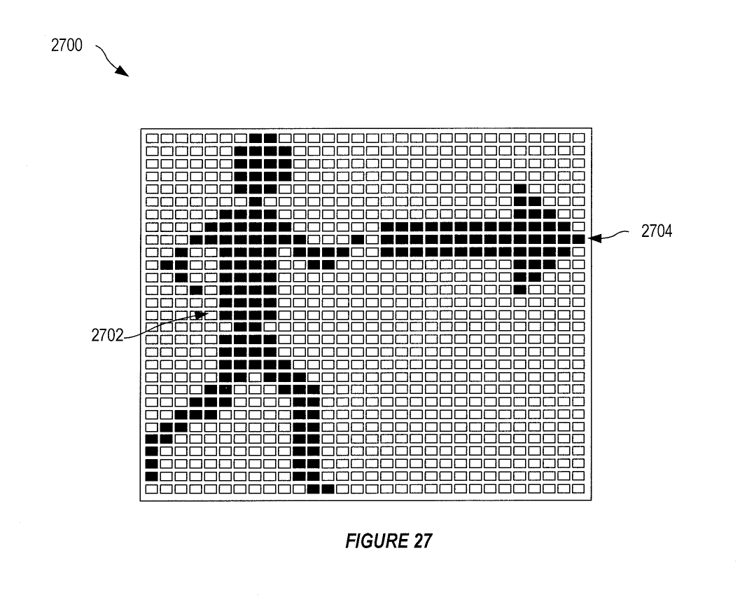

FIG. 27 shows one exemplary frame 2700 for display on an array of light emitting elements having 30 columns by 29 rows that are selectively illuminated to display a walking man 2702 and an arrow 2704. Arrow 2704 and/or walking man 2702 may be intermittently displayed (i.e., flashing).

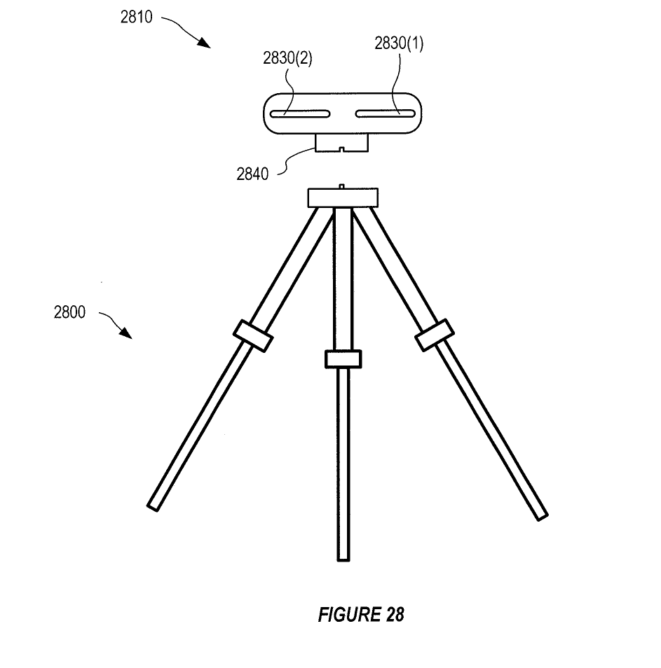

FIG. 28 shows one exemplary tripod 2800 and adapter 2810 for mounting system 100, 200, 1900, and/or 1950 for operation where a traffic barrel is not available. For example, tripod 2800 and adapter 2810 may be used to mount system 100, 200, 1900, and/or 1950 such that LEDs 106 (of systems 100, 200) or display 1906 (of systems 1900, 1950) are visible to approaching motorists (e.g., at road repairs, police check points, and so on). In particular, adapter 2810 may have two mounting holes 2830(1) and 2830(2) that facilitate mounting of traffic beacons (not shown) to tripod 2700. The tripod 2700 contains a mounting neck 2740 that supports the mounting plate 2710 and may rotate to display the traffic beacons (not shown) at differing positions. Tripod 2700 also contains legs 2750 that may fold to permit ease of transportation of tripod.

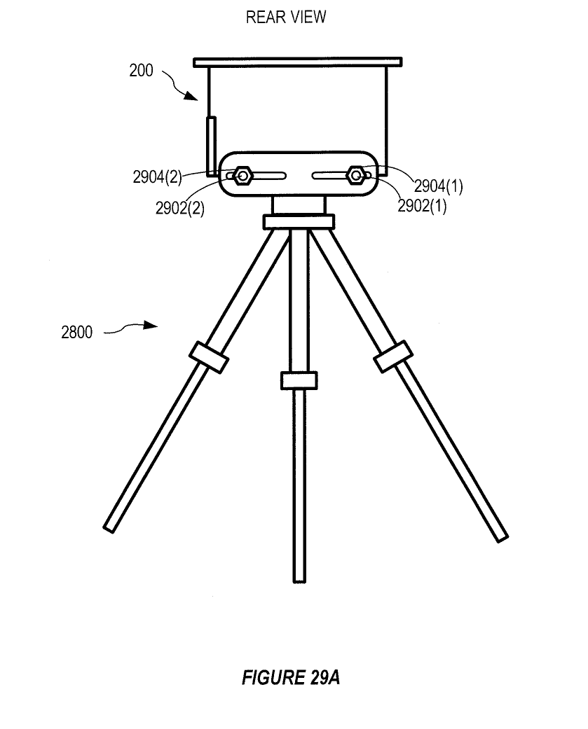

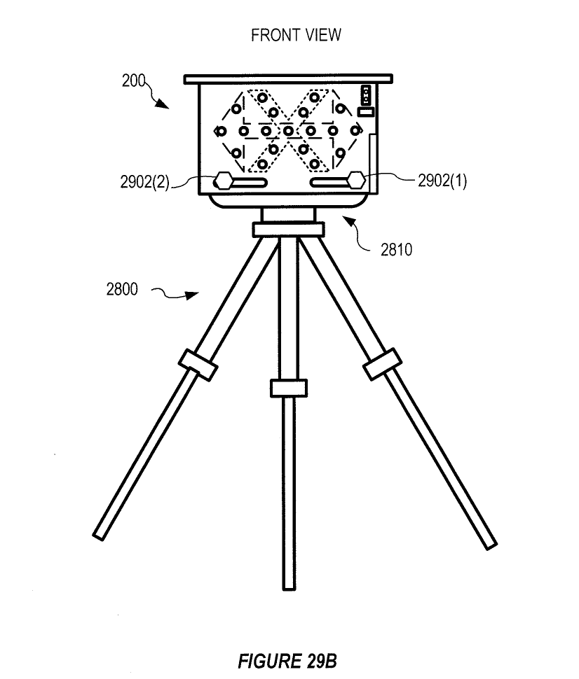

FIGS. 29A and 29B show exemplary rear and front views, respectively, of system 200, FIG. 2, mounted to tripod 2800 via adapter 2810, FIG. 28, by two non-metal (e.g., nylon or other plastic material) bolts 2902(1), 2902(2) and two non-metal (e.g., nylon or other plastic material) nuts 2904(1) and 2904(2). In this example, bolt 2902(1) passes through slot 204(1) of system 200, hole 2830(1) of adapter 2810, and is secured by nut 2904(1). Similarly, bolt 2902(2) may pass through slot 204(2) of system 200, hole 2830(2) of adapter 2810, and is secured by nut 2904(2). Adapter 2810 is secured to tripod 2800.

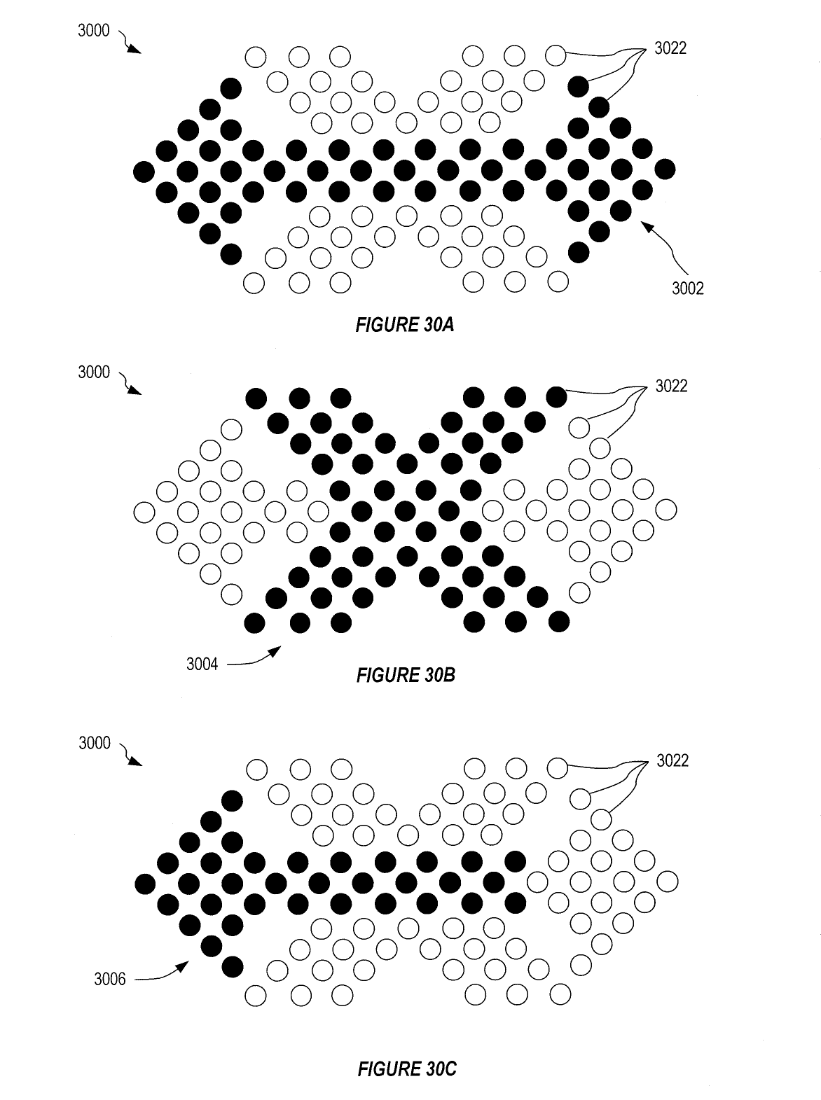

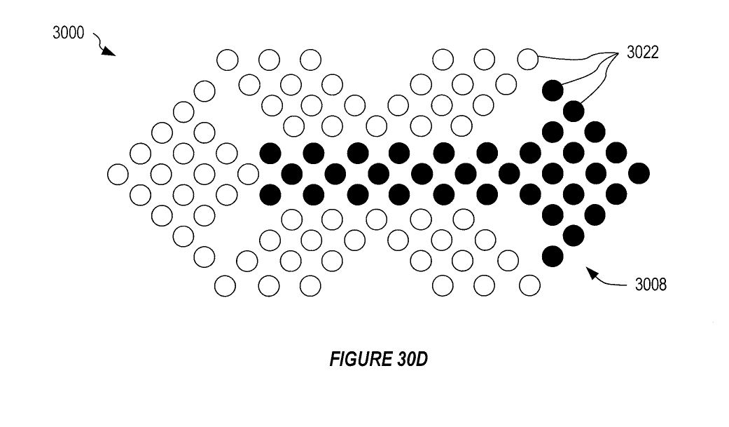

FIGS. 30A, 30B, 30C, and 30D each show an exemplary layout 3000 of ninety-nine LEDs 3022 that may display a double headed arrow 3002, a cross 3004, a left arrow 3006, and/or a right arrow 3008. Layout 3000 may replace the LEDs 106 of system 200, FIG. 2. The use of more LEDs 3022 in layout 3000 enhances the displayed information (e.g., double headed arrow 3002, cross 3004, left arrow 3006 and right arrow 3008), thereby making the displayed information more intelligible to approaching drivers and pedestrians.

FIG. 31 shows one exemplary set 3100 of buttons 3114 for controlling a traffic safety arrow system (e.g., system 100, FIG. 1, system 200, FIG. 2). Set 3100 allows a user to turn the traffic safety arrow system off and on using button 3114(1), and once on, select display of the word “slow” using button 3114(2), select display of a left arrow using button 3114(3), select display of a right arrow using button 3114(4), select display of a double arrow using button 3114(5), and select display of a cross using button 3 114(6). Optionally, buttons 3114(2)-3114(6) may have additional functionality, such as selecting a flashing mode when pressed a second time or held down. Similarly, button 3114(1) may cycle through display brightness options with each press, one of which designating “off.”

FIG. 32 shows one exemplary remote control 3200 for controlling operation of a traffic arrow system (e.g., system 100, FIG. 1 and system 200, FIG. 2) from a remote location. Remote control 3200 is illustrated with buttons 3214 that provide similar control to button 3114 of FIG. 31. Remote control 3200 is shown with an “on/off” button 3214(1), a “slow” selection button 3214(2), a left arrow selection button 3214(3), a right arrow selection button 3214(4), a double arrow selection button 3214(5), and a cross selection button 3214(6). Buttons 3214 may have similar additional functionality to button 3114 of FIG. 31. Remote control 3200 is also shown with a screen 3202 through which an infra-red control signal is transmitted when one or more of buttons 3214 is pressed. In an embodiment, sensor 132 of system 100 detects the infra-red signal transmitted by remote control 3200 and controller 102 decodes the received signal to determine which button is being depressed on remote control 3200 and takes the appropriate action. In this embodiment, the traffic safety arrow system (e.g., system 100, system 200) may omit one or more of switches 114. In an alternate embodiment, remote control 3200 emits a radio frequency signal when one or more of buttons 3214 are depressed and sensor 132 represents a radio frequency receiver such that controller 102 may decode the signal transmitted from remote control 3200.

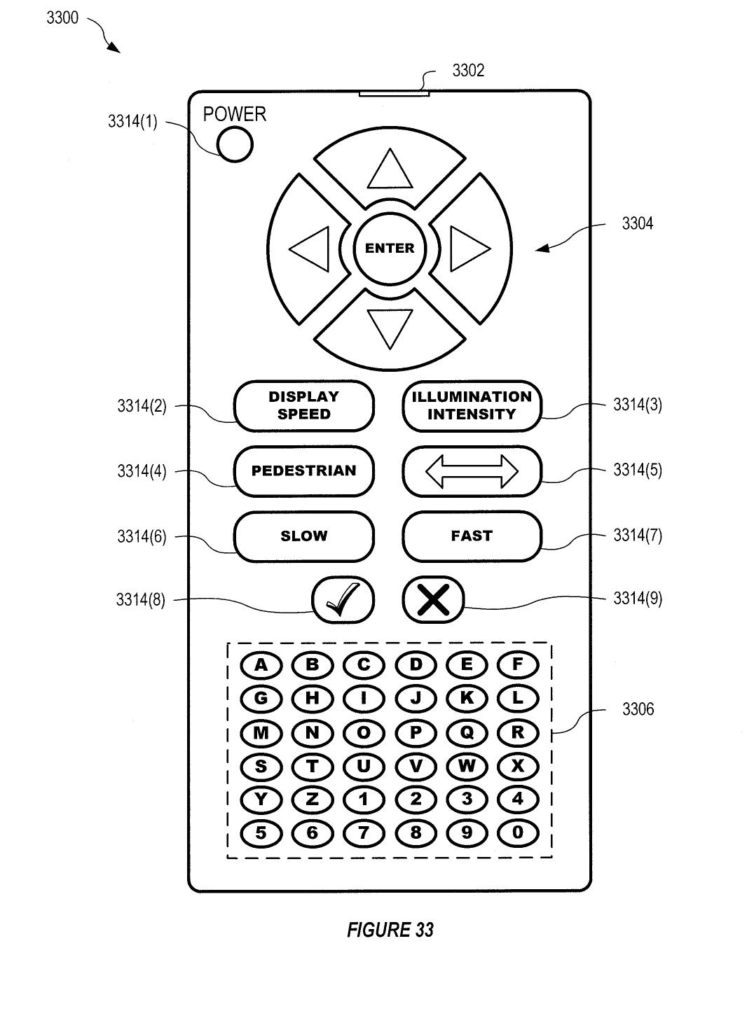

FIG. 33 shows one exemplary remote control device 3300 for controlling a traffic safety arrow system (e.g., system 100, FIG. 1, system 200, FIG. 2, system 1900, FIG. 19A, and/or system 1950, FIG. 19B). Remote control 3300 may operate in a similar manner to remote control 3200, FIG. 32, and is shown with a screen 3302 through which an infra-red control signal is transmitted when one or more of buttons 3314 is pressed. In an embodiment, sensor 132 of system 100 detects the infra-red signal transmitted by remote control 3300 and controller 102 decodes the received signal to determine which button is being depressed on remote control 3300 and takes the appropriate action. Similarly, sensor 1932 of system 1900 detects the infra-red signal transmitted by remote control 3300 and controller 1902 decodes the received signal to determine which button is being depressed on remote control 3300 and takes the appropriate action. In this embodiment, the traffic safety arrow system (e.g., system 1900, system 1950) may omit one or more of switches 1914.

Remote control 3300 is shown with a power button 3314(1) for powering the traffic safety arrow system on and off, three exemplary preset display selection buttons: speed display (e.g., frame 2600, FIG. 26) selection button 3314(2); pedestrian display (e.g., walking man frame 2700 of FIG. 27) selection button 3314(4); and double arrow display (e.g., layout 3000, FIG. 30A) selection button 3314(5). Remote control 3300 is also shown with an illumination intensity selection button 3314(3) that may be used to control the intensity of display 1906, a slow flash selection button 3314(6), and a fast flash selection button 3314(7). Remote control 3300 is also shown with an alpha-numeric keypad 3306 for entering user selected messages for display on the traffic safety arrow system.

Remote control 3300 may include other buttons 3314 that facilitate control of the traffic safety arrow system. For example, remote control 330 is shown with navigation controls 3304 (including an “enter” button) that allows a user scroll through menu selections displayed on the traffic safety arrow system (e.g., displayed on display 1906 of system 1900). That is, display 1906 and navigation controls 3304 of remote control 3300 allow a user to interact with traffic safety arrow system 1900 to select operation of the traffic safety arrow system by selecting one or more displayed menu options. In an embodiment, remote control 3300 includes an accept button 3314(8) and a cancel button 3314(9) that allows the user to accept and cancel, respectively, entered changes to the traffic safety arrow system. In one example of operation, a user programs the phrase “SPEED LIMIT 20” into traffic safety arrow system 1900 using the alpha-numeric keypad 3306, navigation controls 3304, and accept button 3314(8) of remote control 3300.

In an alternate embodiment, remote control 3300 emits a radio frequency signal when one or more of buttons 3314 are depressed, and sensor 1932 represents a radio frequency receiver such that controller 1902 may decode the signal transmitted from remote control 3300.

In an embodiment, one or more buttons 3314 of remote control 3300 are also disposed on the body of the traffic safety arrow system (e.g., as buttons 1914 on enclosure 1952 of traffic safety arrow system 1950, FIG. 19B). For example, these buttons may be implemented on the rear or sides of enclosure 1952.

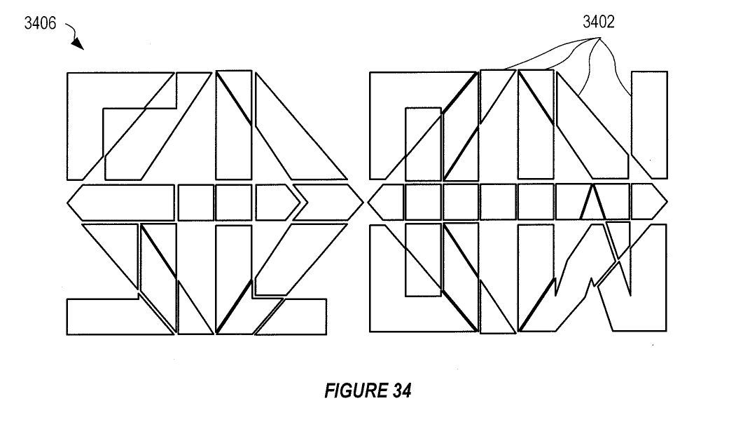

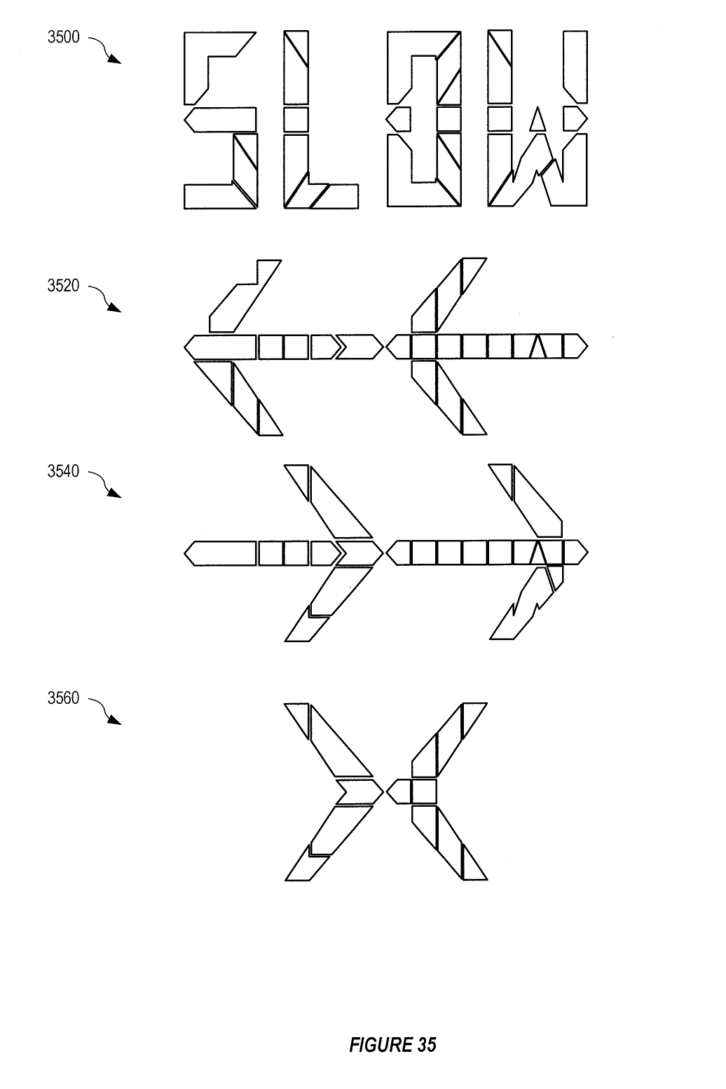

FIG. 34 shows one exemplary display 3406 of the traffic safety arrow systems of FIGS. 1 and 2, the display having a plurality of illuminated segments. In this example, display 3406 has forty-five shaped segments 3402 that may be selectively illuminated to form the previously described displays of traffic safety arrow systems 100 and 200, FIGS. 1 and 2, respectively. Each shaped segment 3402 may be illuminated by one or more LEDs, or other light sources, and may include light channeling and/or diffusing materials. Display 3406 may thus have improved clarity over bare, or simply lensed, LED displays.

FIG. 35 shows exemplary frames 3500, 3520, 3540, and 3560 of display 3406, FIG. 34. In this example, frame 3500 shows selective elements illuminate to display the word “SLOW.” Frame 3520 shows two left arrows that may be independently flashed to show motion, and frame 3540 shows two right left arrows that may be independently flashed to show motion. Frame 3560 shows an “X.”

Changes may be made in the above-described methods and systems without departing from the scope hereof. It should thus be noted that the matter contained in the above description, or shown in the accompanying drawings, should be interpreted as illustrative, and not in a limiting sense. For example, LEDs with shapes other than those shown in the accompanying figures may be used, and the number and spacing of the LEDs may be varied without departing from the scope hereof. The following claims are intended to cover generic and specific features described herein, as well as the scope of the present method and system, which, as a matter of language, might be said to fall there between.

What is claimed is:

1. A traffic safety arrow system for imparting traffic control information to traffic, comprising:
a plurality of light emitting diodes (LEDs);
an input switch for selecting the information to be displayed;
a plurality of solid state switches, each solid state switch connected to one or more of the LEDs;
a controller for reading the input switch and controlling the solid state switches to illuminated the LEDs to display the traffic control information;
a battery for providing power to the traffic safety arrow system;
a voltage controller for generating an operating voltage from the battery to operate the traffic safety arrow system; and
an enclosure for housing the LEDs, the input switch, the solid state switches, the controller, the voltage controller, and the battery, the enclosure having at least two slots formed through a lower part thereof to facilitate attachment of the traffic safety arrow system to a traffic barrel.

2. The system of claim 1, further comprising a solar panel mounted to a top surface of the enclosure, wherein the battery is a rechargeable battery, the voltage controller further operating to charge the rechargeable battery with power from the solar panel.

3. The system of claim 2, wherein the solar panel is sized to match the top surface of the enclosure.

4. The system of claim 2, wherein the enclosure is sized to match the size of the solar panel.

5. The system of claim 1, wherein the battery is at least one consumable battery, the consumable battery being accessible through a battery door within the enclosure such that the battery may be replaced.

6. The system of claim 1, the LEDs being arranged to form one or more of a left arrow, a right arrow, a double arrow, a cross, and the word “slow.”

7. The system of claim 1, the LEDs being arranged to form, upon selective illumination, each of a left arrow, a right arrow, a double arrow, a cross, and the word “slow.”

8. The system of claim 7, the displayed traffic control information being animated.

9. The system of claim 7, the displayed traffic control information flashing.

10. The system of claim 1, the LEDs being arranged as a two-dimensional array.

11. The system of claim 10, the traffic control information being formatted for display on the LEDs based upon the size of the two-dimensional array.

12. The system of claim 10, the traffic control information being scrolled over the LEDs.

13. The system of claim 10, the traffic control information being partially displayed as static and partially displayed as animated.

14. The system of claim 1, further comprising a light sensor, the controller automatically adjusting the brightness of the displayed traffic control information based upon a sensed ambient light level from the light sensor.

15. The system of claim 1, further comprising a remote control, the remote control having at least one button for remotely controlling the traffic safety arrow system.

16. The system of claim 15, the remote control generating an infra-red control signal, the traffic safety arrow system further comprising a sensor for detecting the infra-red control signal.

17. The system of claim 15, the remote control generating a radio frequency control signal, the traffic safety arrow system further comprising a sensor for detecting the radio frequency control signal.

18. A traffic safety method for imparting traffic control information to traffic in a construction zone, comprising:
positioning a traffic barrel to block traffic flow, the traffic barrel having disposed thereon a traffic safety arrow system;
using switches on the traffic safety system to select one of a plurality of display sequences;
determining, if the switches have changed from one of the plurality of display sequences to another of the plurality, a display sequence and a step period, based upon the switches;
displaying, if the switches have changed, the first step of the display sequence;
displaying, if the switches have not changed, a next step in the display sequence; and
repeating the steps of determining and displaying until the traffic safety arrow system is turned off.

19. The traffic safety method of claim 18, the step of positioning comprising attaching the traffic safety arrow system to the traffic barrel using two non-metal bolts and two non-metal nuts, each bolt passing through one of two slots in the traffic safety arrow system and then through one of two mounting holes of the traffic barrel, each bolt then being secured by one of the nuts, wherein the slots facilitate attachment of the traffic safety arrow system to traffic barrels with mounting holes of various widths and sizes.

20. A traffic safety arrow system for imparting traffic control information to traffic, comprising:
means for attaching the traffic safety arrow system to a traffic barrel;
means for selecting the traffic control information for display on the traffic safety arrow system;
means for displaying the traffic control information; and
means for powering the traffic safety arrow system.

21. The traffic safety arrow system of claim 20, further comprising means for powering the traffic safety arrow system from solar energy.

22. The traffic safety arrow system of claim 20, further comprising means for attaching the traffic safety arrow system to a tripod.
